(19) United States
(12) Patent Application Publication
(10) Pub. No.: US 2022/0225586 A1
(43) Pub. Date: Jul. 21, 2022

(54) PLANT GROWING SYSTEM USING WATER EXTRACTED FROM AIR

(71) Applicant: MIDBAR INC., Pohang-si, Gyeongsangbuk-do (KR)

(72) Inventor: Hae Young PARK, Anyang-si (KR)

(73) Assignee: MIDBAR INC., Pohang-si, Gyeongsangbuk-do (KR)

(21) Appl. No.: 17/614,777

(22) PCT Filed: Nov. 19, 2020
(86) PCT No.: PCT/KR2020/016331

§ 371 Date: Nov. 29, 2021

(30) Foreign Application Priority Data
Nov. 27, 2019 (KR) 10-2019-0153947

(51) Int. Cl. A01G 31/00; B01D 5/00; B01D 53/26; B01F 31/80; B01F 35/75

(52) U.S. Cl. CPC A01G 31/00; B01D 5/0003; A01G 2031/006; B01F 31/80; B01F 35/7547; B01D 53/265

(57) ABSTRACT

A plant growing system using water extracted from air, the system which has a Peltier element connected to a power supply and includes a heat dissipating member and a cooling member to collect condensate by condensing moisture in the air. The plant growing system includes: a mixing part having a storage tank and a nutrient supply tank, the storage tank into which condensate obtained from the air is introduced and stored, and the nutrient supply tank which is connected to the storage tank so that a predetermined amount of nutrients is supplied through a nutrient control valve; an atomizer having one side connected to a compressor whose opening and closing is controlled by an injection valve, the atomizer being connected to the mixing part via a pipe so that a solution flows and is then stored in the atomizer.

### BACKGROUND OF THE DISCLOSURE

### Field of the Disclosure

The present disclosure relates to a plant growing system using water extracted from air and, more particularly, a plant growing system using water extracted from air, the system obtaining water necessary for plant growth from the air and sprays a solution, in which nutrients are dissolved in collected water, in the form of mist, so that water, air, and nutrients are supplied to plant roots.

### Related Art

Water, which is an essential element for not only plant growth but also survival, plays a pivotal role in plant metabolism such as photosynthesis, nitrogen assimilation, transpiration, and absorption of inorganic nutrients from plant roots. Water forms the molecular structure of numerous cell components such as carbohydrates, nucleic acids, and proteins. Also, as a solvent, water dissolves metabolites in cells and ionizes the metabolites to facilitate transport of the metabolites. Water is absorbed through the epidermal cells of root hairs of a plant, and when water is insufficient, the plant withers and it is hard for the plant to survive. In addition, there are 16 essential elements for plant growth, and there are 9 macro elements and 7 micro elements. Among the elements, carbon C, hydrogen H, and oxygen O may be obtained from water and air, and other elements are nutrients obtained from the soil. Elements lacking depending on an environment are provided with fertilizers, etc.

In order to supply water which is an essential element for plant growth, as described above, Korean Patent Application Publication No. 10-2012-0003207 discloses a flowerpot automatic water supply system, and the system includes: a pail 11 for storing water in a water supply body 10; a water feed pump 12 supplying water stored in the pail 11; a power supply device 13 operating the water feed pump 12; and an automatic controller 14 receiving power from the power supply device 13 to control the operation of the water feed pump 12. The water supply pump 12 is connected to a flower pot 100 through a supply line 20 in which a supply pipe 12a is composed of a hose 21 and a nozzle 22, so that the water supply pump is operated according to a time, which is set in the automatic controller 14, to automatically supply a predetermined amount of water.

However, in the aforementioned related art, it is necessary to constantly supply water to the pail in order to supply water to the flowerpot, and for this purpose, additional equipment such as the water feed pump is required. In addition, since a water source that can supply water must exist, there may be spatial restrictions on an installation place.

### RELATED ART DOCUMENT

### Patent Document

Korean Patent Application Publication No. 10-2012-0003207 (Jan. 10, 2012)

### SUMMARY

The present disclosure provides a plant growing system using water extracted from water, the system which enables obtaining of water without any restriction on place and space, and which allows water, which is is essential for plant growth, to be obtained from air even in an extreme environment and provided with nutrients so that a plant can grow even in a place where watering is difficult.

In an aspect, there is provided a plant growing system using water extracted from air, the system which has a Peltier element connected to a power supply and includes a heat dissipating member and a cooling member to collect condensate by condensing moisture in the air. The plant growing system includes: a mixing part having a storage tank and a nutrient supply tank, the storage tank into which condensate obtained from the air is introduced and stored, and the nutrient supply tank which is connected to the storage tank so that a predetermined amount of nutrients is supplied through a nutrient control valve; an atomizer having one side connected to a compressor whose opening and closing is controlled by an injection valve, the atomizer being connected to the mixing part via a pipe so that a solution flows and is then stored in the atomizer, and the atomizer comprising a mist cannon comprising a plurality of micro holes at an end to spray the solution; and a growth part 30 having one side which is penetrated by the plurality of micro holes, and provided with a growing bag in which a plurality of plants are arranged and fixed with roots, which are under stems, facing inward.

As described above, it is not necessary to secure a water source and a complicated irrigation facility using the water source, and it is possible to grow plants without an administrators physical labor for watering. In addition, efficient plant cultivation is possible by dissolving nutrients in water, spraying the nutrients in the form of mist, and supplying the nutrients to plant roots. A space where plants are placed, fixed, and grown is configured in a modular form like a seedling tray plate, so replacement and changing of a configuration are easy and free, thereby maximizing convenience.

### BRIEF DESCRIPTION OF THE DRAWINGS

FIGS. 1 to 2 are configuration diagrams each illustrating a plant growing system using water extracted from air according to an embodiment of the present disclosure.

FIG. 3 is a detailed configuration diagram of a growing bag provided in a plant growing system using water extracted from air according to an embodiment of the present disclosure.

### DESCRIPTION OF EXEMPLARY EMBODIMENTS

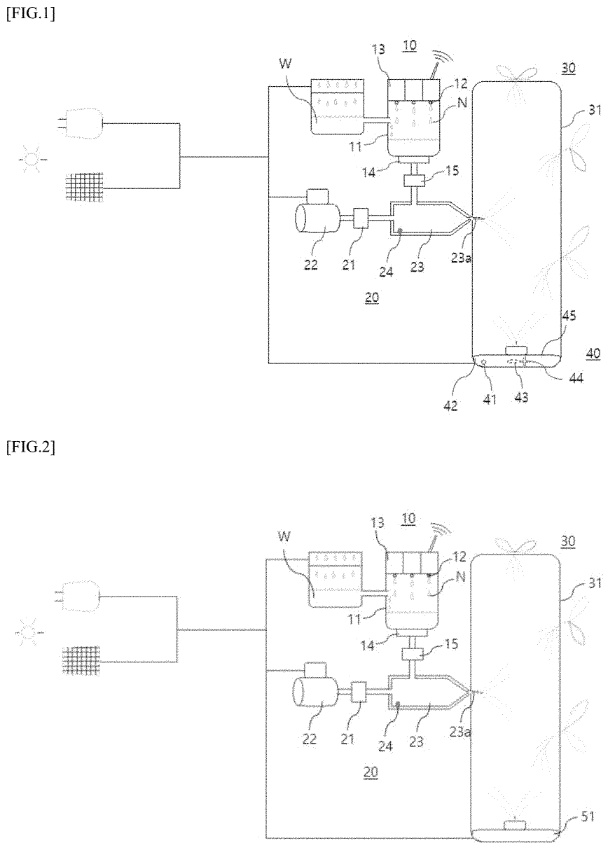

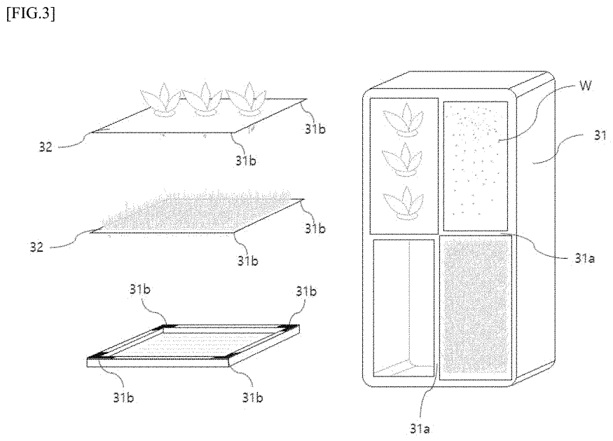

FIGS. 1 to 3 are configuration diagrams and a detailed configuration diagram of a plant growing system using water extracted from air according to an embodiment of the present disclosure. A detailed configuration of the present disclosure will be described with reference to the accompanying drawings.

The present disclosure provides a plant growing system using water extracted from air, the system which has a Peltier element connected to a power supply and having a heat dissipating member and a cooling member to collect condensate W by condensing moisture in the air. The plant growing system includes: a mixing part 10 having a storage tank 11 and a nutrient supply tank 13, the storage tank 11 into which condensate W obtained from the air is introduced and stored, and the nutrient supply tank 13 which is connected to the storage tank 11 so that a predetermined amount of nutrients N is supplied through a nutrient control valve 12; an atomizer 20 having one side connected to a compressor 22 whose opening and closing is controlled by an injection valve 21, the atomizer 20 being connected to the mixing part 10 via a pipe so that a solution flows and is then stored in the atomizer 20, and the atomizer 20 comprising a mist cannon 23 comprising a plurality of micro holes 23a at an end to spray the solution; and a growth part having one side which is penetrated by the plurality of micro holes 23a, and provided with a growing bag 31 in which a plurality of plants are arranged and fixed with roots, which are under stems, facing inward. As the solution stored in the mist cannon 23 passes through the plurality of micro holes 23a due to the compressor 22, the solution is sprayed as ultra-fine particles of mist, so that absorption of the solution at plant roots may be maximized. Also, an ultrasonic generator may be additionally provided in the mist cannon 23 to enable atomization into ultra-fine particles.

The mixing part 10 is configured to be rotatable at a high speed, and an ultrasonic generator 14 is provided below the mixing part 10 so that the nutrients N are crushed into ultra-fine particles and dissolved. A mixed solution control valve 15 is provided at a connection part connected to mist cannon 23 below the ultrasonic generator 14 to control a flow of a mixed solution in which the condensate W and the nutrients N are mixed. By the ultrasonic generator 14, the nutrients N are formulated in a state in which the nutrients N are optimized for dissolution, and when the solution is sprayed in the form of mist, an absorption rate of the solution at plant roots may be maximized

In addition, a flow rate sensor 24 is provided in the mist cannon 23 so that when a preset amount of solution or more is introduced, the mixed solution control valve 15 is closed, the injection valve 21 is opened, and compressed air is injected toward the mist cannon 23. The injection valve 21 in an opened state allows compressed air to be injected for a predetermined period of time and continues the injection of the air despite exhaustion of the mixed solution to remove fine particles or foreign substances deposited in the plurality of micro holes 23a. In doing so, in addition to carbon C, oxygen O, and hydrogen H, which are essential elements for plant growth and can be obtained from air, water, and nutrients, which are other essential elements, may be quickly delivered to a plant to promote growth of the plant. This enables efficient administration by eliminating the labor of an administrator opening and closing the injection valve for water supply. Furthermore, an automatic nozzle cleaning function is provided by injecting only compressed air, which may reduce labor of the administrator.

The nutrient control valve 12, the mixed solution control valve 15, and the injection valve 21 may be configured to be opened and closed when each specific condition is met. In addition, the opening and closing of the nutrient control valve 12, the mixed solution control valve 15, and the injection valve 21 may be controlled remotely through a configuration such as the Internet of Things (IoT) or may be controlled through a central management device. This method may be freely applied according to an installation environment or management, and may enable a combination for the maximum effect.

In addition, the mixed solution control valve 15 may count the number of times the mist cannon 23 is filled with the mixed solution. When the reference number of fillings is determined, the mixed solution control valve 15 may maintain a closed state for a predetermined period of time, thereby enabling automatic nozzle cleaning with compressed air injection through the injection valve 21.

The growing bag 31 is made of a waterproofing material and is sealed so that a sprayed solution does not leak to the outside. In doing so, a growing environment is created, in which water and nutrients contained in the water are not leaked to the outside and can be sufficiently absorbed by the roots. In addition, a recirculation atomizer 40 is provided inside at a bottom of the growing bag 31 and includes a water tank 42 and a housing 45. The water tank 42 is connected to a suction pipe 41 for sucking moisture of a solution, which has been condensed and descended without being absorbed by roots, and the water tank 42 includes an ultrasonic vibrator 43 and a fan 44. The housing 45 surrounds the water tank 42, has a hollow inside, and has an upper portion that narrows with an open side. In doing so, it is possible to maximize the efficiency by reusing the mixed solution that is collected at the bottom after the mist containing the nutrients and water sprayed primarily is not absorbed and condensed. In this case, the ultrasonic vibrator 43 makes the mixed solution into fine particles, and the fan 44 generates an internal circulating airflow, so that the mist is sprayed into an upper opening. In addition, a centrifugal atomizer 51 for sucking the solution, which has been condensed and descended without being absorbed by the roots, changing the solution into fine particles, and discharging the fine particles is provided at a bottom of the growing bag 31, so that water and nutrients are re-sprayed to the plant roots. The centrifugal atomizer 51 sucks the descending solution and sprays the solution with a rotating disk to scatter due to a centrifugal force. In doing so, a reuse rate of the solution is increased by using a spraying method to refine the solution particles by colliding with a fixed object, thereby maximizing the system efficiency.

The growing bag 31 is provided with a partition 31a inside to divide a space into sections, and a velcro 31b is provided at an outer circumference that is formed to be open by the division. A grow plate 32, in which the plant roots are planted in an inner area and which comprises a velcro 31b provided at an inner circumference, is coupled to an outer circumference of the growing bag 31.

As described above, it is not necessary to secure a water source to supply water through a plant growing system using water extracted from air, and there is no need to have a complex irrigation facility using the water source. In addition, it is possible to grow plants without an administrator's physical labor for watering. In addition, efficient plant cultivation is possible by dissolving nutrients in water, spraying the nutrients in the form of mist, and supplying the nutrients to plant roots. A space where plants are placed, fixed, and grown is configured in a modular form like a seedling tray plate, so replacement and changing of a configuration are easy and free, thereby maximizing convenience.

While the present disclosure has been shown and described with respect to particular embodiments and applications, it may be obvious to those skilled in the art that various modifications and variations can be made without departing from the spirit and scope of the the present disclosure as set forth in the appended claims.

[Detailed Description of Main Elements]

| | |
|---|---|
| N: nutrients | W: condensate |
| 10: mixing part | 11: storage tank |
| 12: nutrient control valve | 13: nutrient supply tank |
| 14: ultrasonic generator | 15: mixed solution control valve |
| 20: atomizer | 21: injection valve |
| 22: compressor | 23: mist cannon |
| 23a: micro hole | 24: flow sensor |
| 30: growth part | 31: glowing bag |
| 31a: partition | 31b: velcro |
| 32: grow plate | 40: recirculation atomizer |
| 41: suction pipe | 42: water tank |
| 43: ultrasonic vibrator | 44: fan |
| 45: housing | 51: centrifugal atomizer |

1-6. (canceled)

7. A plant growing system using water extracted from air, the system having a Peltier element that is connected to a power supply and comprises a heat dissipating member and a cooling member to collect condensate by condensing moisture in the air, the system comprising:
a mixing part having a storage tank and a nutrient supply tank, the storage tank into which condensate obtained from the air is introduced and stored, and the nutrient supply tank which is connected to the storage tank so that a predetermined amount of nutrients is supplied through a nutrient control valve;
an atomizer having one side connected to a compressor whose opening and closing is controlled by an injection valve, the atomizer being connected to the mixing part via a pipe so that a solution flows and is then stored in the atomizer, and the atomizer comprising a mist cannon comprising a plurality of micro holes at an end to spray the solution; and
a growth part having one side which is penetrated by the plurality of micro holes, and provided with a growing bag in which a plurality of plants are arranged and fixed with roots, which are under stems, facing inward.

8. The system of claim 7,
wherein the mixing part is configured to be rotatable at a high speed, and an ultrasonic generator is provided below the mixing part so that the nutrients are crushed into ultra-fine particles and dissolved, and
wherein a mixed solution control valve is provided at a connection part connected to mist cannon below the ultrasonic generator to control a flow of a mixed solution in which the condensate W and the nutrients are mixed.

9. The system of claim 7,
wherein a flow rate sensor is provided in the mist cannon so that when a preset amount of solution or more is introduced, the mixed solution control valve is closed, the injection valve is opened, and compressed air is injected toward the mist cannon, and
wherein the injection valve in an opened state allows compressed air to be injected for a predetermined period of time and continues the injection of the air despite exhaustion of the mixed solution to remove fine particles or foreign substances deposited in the plurality of micro holes.

10. The system of claim 7,
wherein the growing bag is made of a waterproofing material and is sealed so that sprayed solution does not leak to an outside,
wherein a recirculation atomizer is provided inside at a bottom of the growing bag and comprises a water tank and a housing, the water tank is connected to a suction pipe for sucking a solution, which has been condensed and descended without being absorbed by roots, the water tank comprises an ultrasonic vibrator and a fan, and the housing surrounds the water tank, has a hollow inside, and has an upper portion that narrows with an open side.

11. The system of claim 7,
wherein the growing bag is made of a waterproofing material and is sealed so that sprayed solution does not leak to an outside, and
wherein a centrifugal atomizer is provided at a bottom of the growing bag to sucks a solution condensed and descended without being absorbed by roots, changes the solution into fine particles, and discharges the fine particles, so that misted solution is re-sprayed to plant roots.

12. The system of claim 10,
wherein the glowing bag is provided with a partition inside to divide a space into sections, and a velcro is provided at an outer circumference formed to be open by the division, and
wherein a grow plate, in which the plant roots are planted in an inner area and which comprises a velcro 31b provided at an inner circumference, is coupled to an outer circumference of the growing bag.

13. The system of claim 11,
wherein the glowing bag is provided with a partition inside to divide a space into sections, and a velcro is provided at an outer circumference formed to be open by the division, and
wherein a grow plate, in which the plant roots are planted in an inner area and which comprises a velcro 31b provided at an inner circumference, is coupled to an outer circumference of the growing bag.
